(19) United States
(12) Patent Application Publication
(10) Pub. No.: US 2025/0187340 A1
(43) Pub. Date: Jun. 12, 2025

(54) INKJET RECORDING APPARATUS

(71) Applicant: KYOCERA Document Solutions Inc., Osaka (JP)

(72) Inventors: Takashi MORITA, Osaka-shi (JP); Tomohiro SUE, Osaka-shi (JP); Tatsuhiko YOSHII, Osaka-shi (JP)

(73) Assignee: KYOCERA Document Solutions Inc., Osaka (JP)

(21) Appl. No.: 18/967,552

(22) Filed: Dec. 3, 2024

(30) Foreign Application Priority Data
Dec. 6, 2023 (JP) 2023-205896

(51) Int. Cl. B41J 2/165; B41J 2/21

(52) U.S. Cl. CPC B41J 2/16552; B41J 2/2103; B41J 2002/16564

(57) ABSTRACT

An inkjet recording apparatus includes a plurality of inkjet heads, a cleaning liquid supply device, a removing device, a closing member, a surrounding member and a housing device. The cleaning liquid supply device supplies a cleaning liquid to the inkjet heads. The removing device removes adhered material from nozzle surfaces of the inkjet heads. The closing member closes a gap between the inkjet heads. The surrounding member surrounds the removing device and is opened toward the inkjet heads. The housing device houses the nozzle surfaces in a space formed by the closing member and the surrounding member when the adhered material is removed by the removing device.

### INCORPORATION BY REFERENCE

This application is based on and claims the benefit of priority from Japanese patent application No. 2023-205896 filed on Dec. 6, 2023, which is incorporated by reference in its entirety.

### BACKGROUND

The present disclosure relates to an inkjet recording apparatus.

In an inkjet recording apparatus, moisture evaporates from ink in a nozzle of an inkjet head during a period when an image forming job is not executed, and the nozzle is clogged by an increase in viscosity of the ink. To prevent the clogging, the ink in the nozzle is purged to the cap. However, if the ink remaining on the nozzle surface is left, there is a problem that the ink falls on the sheet during the execution of the image forming job or the ink sticks to the nozzle surface. Therefore, a technique for removing the ink remaining on the nozzle surface has been studied. For example, a configuration has been proposed in which the ink is removed from the nozzle surface by sliding a blade in contact with the nozzle surface.

In the above configuration, since a cleaning liquid is swelled from a hole of a supply member adjacent to the nozzle surface and the blade slides along the nozzle surface after scraping the cleaning liquid, there is a problem that the cleaning liquid easily leaks to the periphery. Further, since an amount of the cleaning liquid supplied to the nozzle surface is small, there is also a problem that an ink removing ability is low. It is expected that the ink removing ability is improved by supplying a larger amount of the cleaning liquid, but there is a problem that the leakage to the periphery increases when an amount of the supplied cleaning liquid is increased.

### SUMMARY

An inkjet recording apparatus according to the present disclosure includes a plurality of inkjet heads, a cleaning liquid supply device, a removing device, a closing member, a surrounding member and a housing device. The cleaning liquid supply device supplies a cleaning liquid to the inkjet heads. The removing device removes adhered material from nozzle surfaces of the inkjet heads. The closing member closes a gap between the inkjet heads. The surrounding member surrounds the removing device and is opened toward the inkjet heads. The housing device houses the nozzle surfaces in a space formed by the closing member and the surrounding member when the adhered material is removed by the removing device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing an internal configuration of an inkjet recording apparatus according to one embodiment of the present disclosure.

FIG. 2 is a perspective view showing an arrangement of inkjet heads according to the embodiment of the present disclosure.

FIG. 3 is a cross-sectional view showing the inkjet head according to the embodiment of the present disclosure.

FIG. 4 is a diagram schematically showing a configuration of an ink supply part according to the embodiment of the present disclosure.

FIG. 5 is a block diagram showing an electrical configuration of a maintenance device according to the embodiment of the present disclosure.

FIG. 6 is a perspective view showing an image forming unit according to the embodiment of the present disclosure.

FIG. 7 is a disassembled view showing the image forming unit according to the embodiment of the present disclosure.

FIG. 8 is a perspective view showing the maintenance device according to the embodiment of the present disclosure.

FIG. 9 is a perspective view showing the maintenance device according to the embodiment of the present disclosure.

FIG. 10 is a perspective view showing the maintenance device according to the embodiment of the present disclosure.

FIG. 11 is a perspective view showing the maintenance device according to the embodiment of the present disclosure.

FIG. 12 is a perspective view showing a removing device according to the embodiment of the present disclosure.

FIG. 13 is a disassembled view showing the removing device according to the embodiment of the present disclosure.

FIG. 14 is a cross-sectional view showing the removing device according to the embodiment of the present disclosure.

FIG. 15 is a cross-sectional view showing the removing device according to the embodiment of the present disclosure.

FIG. 16 is a cross-sectional view showing the removing device according to the embodiment of the present disclosure.

### DETAILED DESCRIPTION

Hereinafter, with reference to the drawings, an inkjet recording apparatus 1 according to the present embodiment of the present disclosure will be described.

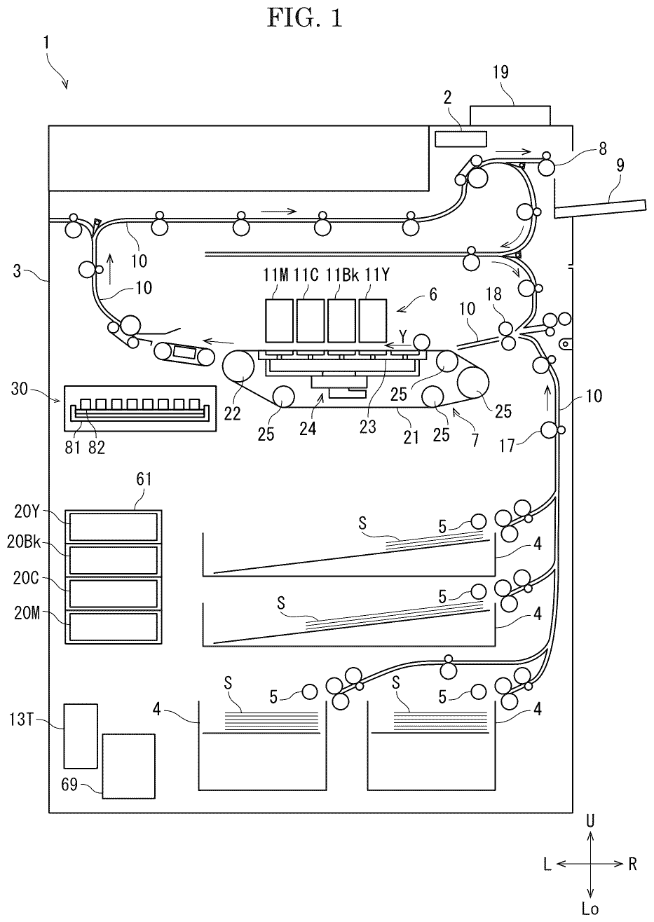

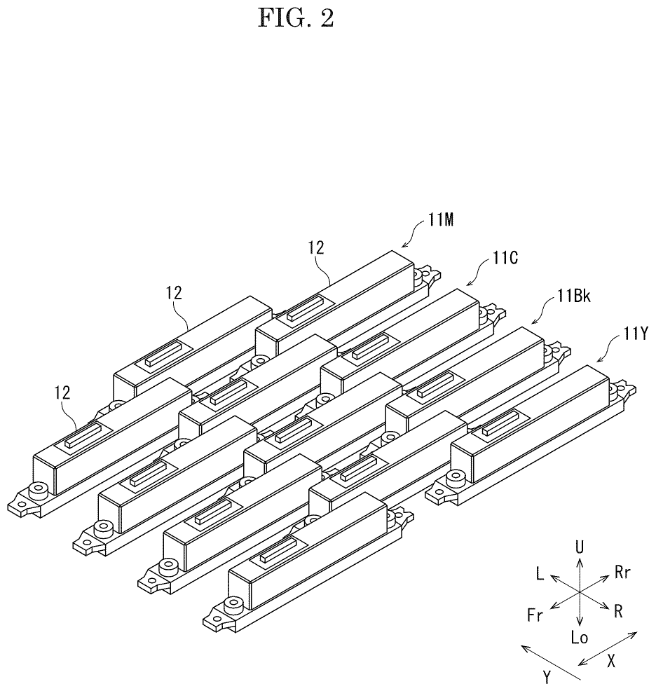

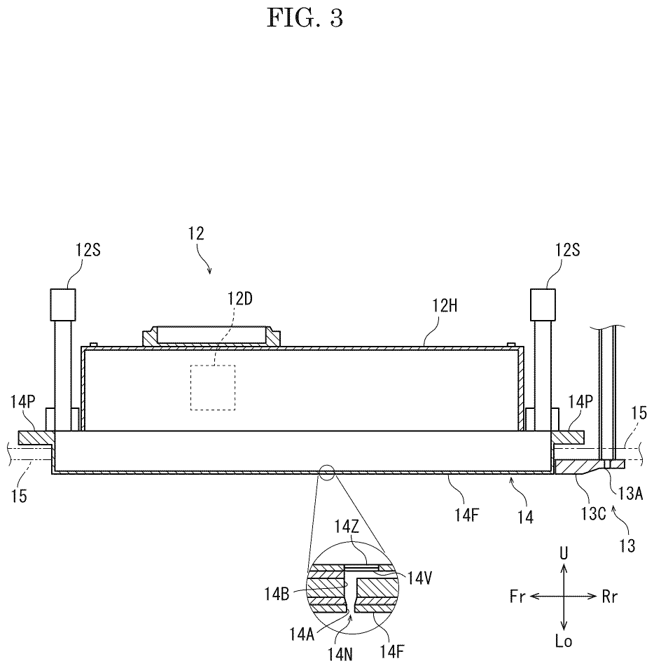

First, an entire configuration of the inkjet recording apparatus 1 will be described. FIG. 1 is a front view schematically showing the inkjet recording apparatus 1. FIG. 2 is a perspective view showing an arrangement of inkjet heads 12. FIG. 3 is a cross-sectional view showing the inkjet head 12. Hereinafter, the front side of the paper surface on which FIG. 1 is drawn is defined as the front side of the inkjet recording apparatus 1, and the left-and-right direction will be described with reference to the direction in which the inkjet recording apparatus 1 is viewed from the front side. In each drawing, U, Lo, L, R, Fr and Rr indicate the upper, lower, left, right, front and rear, respectively.

The inkjet recording apparatus 1 (see FIG. 1) includes a box-shaped body housing 3. In the lower portion in the body housing 3, a sheet feeding cassette 4 in which sheets S such as a plain paper and a coated paper are stored, and a sheet feeding roller 5 which feeds the sheets S rightward from the sheet feeding cassette 4 are provided. Above the sheet feeding cassette 4, a conveying unit 7 which attracts and conveys the sheet S in the Y direction is provided. Above the conveying unit 7, an image forming unit 6 which forms an image by ejecting ink is provided. In the right upper portion in the body housing 3, a discharge roller 8 which discharges the sheet S on which the image is formed and a discharge tray 9 on which the discharged sheet S are stacked are provided.

Inside the body housing 3, a conveyance path 10 is provided from the sheet feeding roller 5 to the discharge roller 8 through a gap between the conveying unit 7 and the image forming unit 6. The conveyance path 10 is mainly formed of plate-like members facing each other with a gap for passing the sheet S, and a conveying roller 17 for conveying the sheet S while holding the sheet S is provided at a plurality of positions in the conveyance direction Y. A registration roller 18 is provided on the upstream side of the image forming unit 6 in the conveyance direction Y.

The conveying unit 7 includes an endless conveying belt 21, a support plate 23 and a suction part 24. The conveying belt 21 has a large number of air holes (not shown), and is wound around a driving roller 25 and a driven roller 22. The support plate 23 has a large number of air holes (not shown), and its upper surface is in contact with the inner surface of the conveying belt 21. The suction part 24 sucks air through the air holes of the conveying belt 21 and the air holes of the support plate 23, so that the sheet S is attracted to the conveying belt 21. When the driving roller 25 is driven in the counterclockwise direction by a driving part (not shown) including a motor and a reduction gear, the conveying belt 21 travels in the counterclockwise direction, and the sheet S attracted to the conveying belt 21 is conveyed.

The image forming unit 6 includes head units 11Y, 11Bk, 11C and 11M (collectively referred to as the head unit 11). The head unit 11 includes one or more inkjet heads 12, for example, three inkjet heads 12 arranged in a staggered pattern (see FIG. 2). Ink containers 20Y, 20Bk, 20C and 20M (collectively referred to as the ink container 20) filled with the black, cyan, magenta, and yellow ink are connected to the respective head units 11.

The inkjet head 12 (see FIG. 3) includes a rectangular parallelepiped housing 12H whose longitudinal direction is along the front-and-rear direction, a nozzle plate 14 provided at the bottom of the housing 12H, and a socket 12S to which a pipe for supplying the ink is connected. The nozzle plate 14 is provided with a large number of nozzles 14N arranged in the front-and-rear direction. The nozzle 14N includes a branch channel 14B branched from the downstream side of the socket 12S, and an ejection port 14A provided on a nozzle surface 14F which is the lower surface of the nozzle plate 14. A diaphragm 14V also serves as a part of the inner wall of the branch channel 14B. The diaphragm 14V is provided with a pressurizing element 14Z. As the pressurizing element 14Z, a piezoelectric element, an electrostatic actuator, a heater or the like are used. A driving circuit 12D for driving the pressurizing element 14Z is connected to the pressurizing element 14Z.

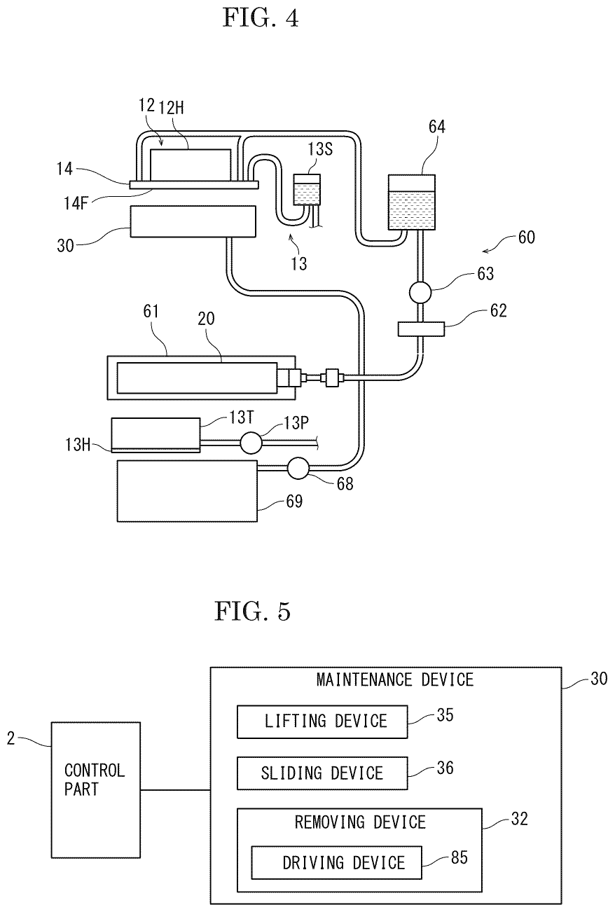

The inkjet recording apparatus 1 includes an ink supply part 60 (see FIG. 4). In the figure, one ink supply part 60 corresponding to one color ink is shown, but since the four colors of the ink are used in this embodiment, the same four ink supply parts 60 are provided. The inkjet recording apparatus 1 includes a container attachment part 61 to which the ink container 20 is attached, a filter 62 which filters the ink, a pump 63 which sucks the ink from the ink container 20 through the filter 62, and a sub-tank 64 which stores the ink fed from the pump 63.

A liquid level in the sub-tank 64 is adjusted to be slightly lower than the nozzle surface 14F. Negative pressure acts on the ink in the nozzle 14N by a head difference between the liquid surface and the nozzle surface 14F, and a meniscus is formed in the nozzle 14N. After the ink is ejected from the inkjet head 12, a surface tension of the ink acts to reduce the surface area of the meniscus, and the ink of the reduced amount is drawn into the inkjet head 12 from the sub-tank 64 by a negative pressure generated thereby.

A control part 2 (see FIG. 1) includes an arithmetic part and a storage part (not shown). The arithmetic part is, for example, a CPU (Central Processing Unit). The storage part includes a storage medium such as ROM (Read Only Memory), RAM (Random Access Memory), EEPROM (Electrically Erasable Programmable Read Only Memory), and the like. The arithmetic part reads the control program stored in the storage part and executes various processes. The control part 2 may be implemented by an integrated circuit that does not use software.

A display operation part 19 is provided on the upper portion of the body housing 3 (see FIG. 1, FIG. 2). The display operation part 19 includes a display panel, a touch panel laminated on the display panel, and a keypad (not shown). The control part 2 displays a screen representing an operation menu, a status, or the like of the inkjet recording apparatus 1 on the display panel, and controls each part of the inkjet recording apparatus 1 in accordance with the operation detected by the touch panel and the keypad.

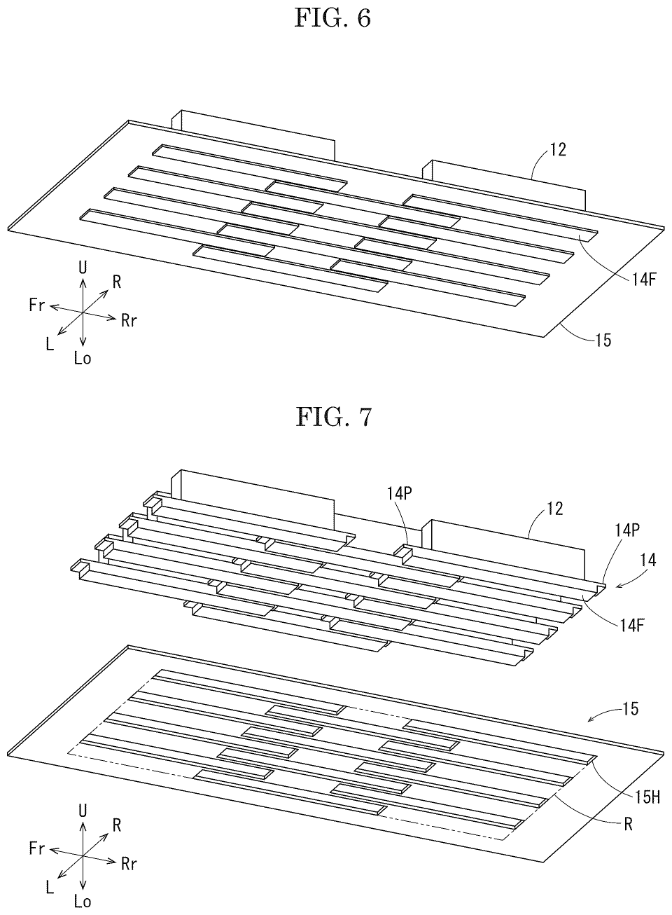

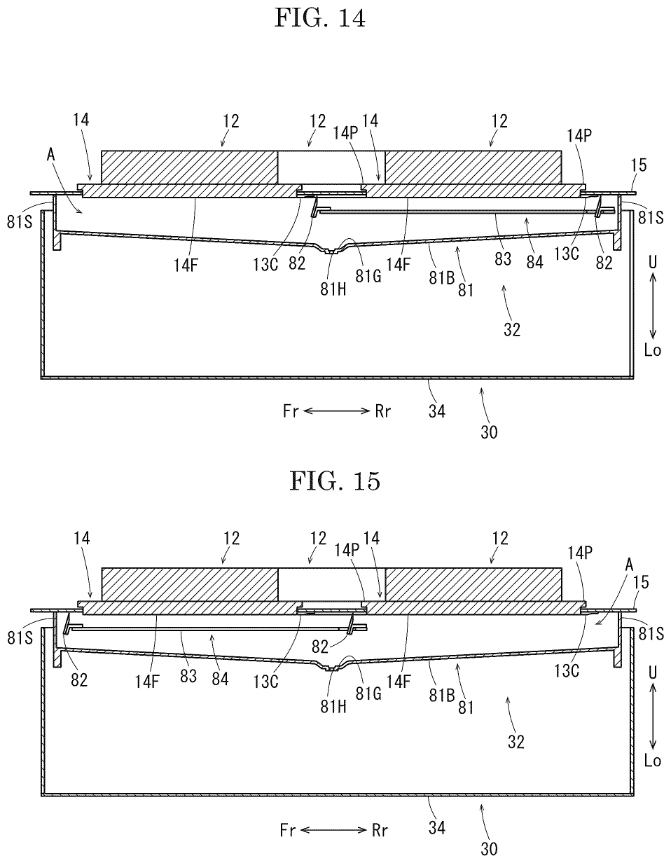

The basic image forming operation of the inkjet recording apparatus 1 is as follows. When an image forming job is inputted to the inkjet recording apparatus 1 from the display operation part 19 or an external computer, the sheet feeding roller 5 feeds the sheet S from the sheet feeding cassette 4 to the conveyance path 10, and the registration roller 18 whose rotation is stopped corrects the skew of the sheet S. When the registration roller 18 sends the sheet S to the conveying unit 7 at a predetermined timing, the conveying unit 7 attracts the sheet S to the conveying belt 21, and conveys the sheet S in the Y direction. The driving circuit 12D supplies an ejection signal corresponding to the image data to the pressurizing element 14Z in synchronization with the conveyance of the sheet S. Thus, the ink is ejected from the nozzle 14N to form an image on the sheet S. The discharge roller 8 discharges the sheet S on which the image is formed to the discharge tray 9.

[Head Base] FIG. 6 is a perspective view showing the image forming unit 6. FIG. 7 is a disassembled view showing the image forming unit 6. FIG. 14 to FIG. 16 are cross-sectional views showing a removing device 32. The image forming unit 6 includes a plurality (in this embodiment, four) of the head units 11 and a head base 15. The head base 15 is fixed to the body housing 3 and supports the head units 11.

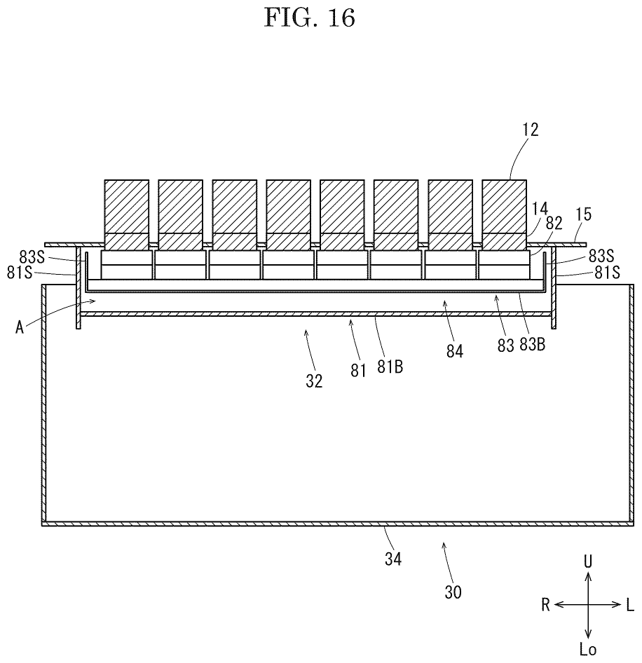

The head base 15 is a rectangular flat plate member. A size of the head base 15 in the front-and-rear direction and the left-and-right direction is larger than that of a circumscribed rectangle R (see FIG. 7) that includes all the nozzle surfaces 14F. In other words, a length of the head base 15 in the front-and-rear direction (see FIG. 14) is longer than a length from the front end of the nozzle surface 14F of the frontmost inkjet head 12 to the rear end of the nozzle surface 14F of the rearmost inkjet head 12. A length of the head base 15 in the left-and-right direction (see FIG. 16) is longer than a length from the left end of the nozzle surface 14F of the leftmost inkjet head 12 to the right end of the nozzle surface 14F of the rightmost inkjet head 12.

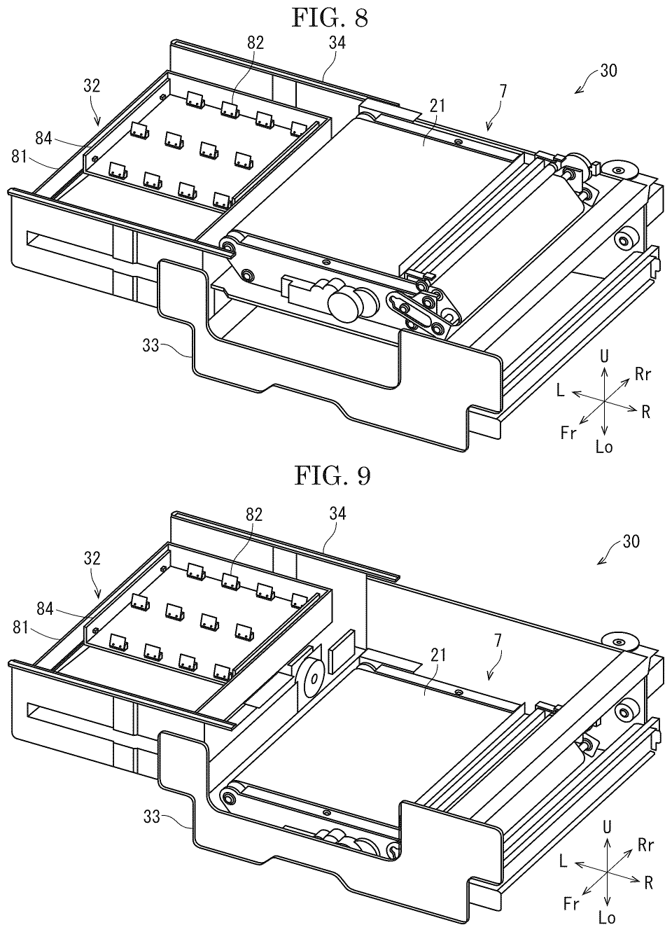

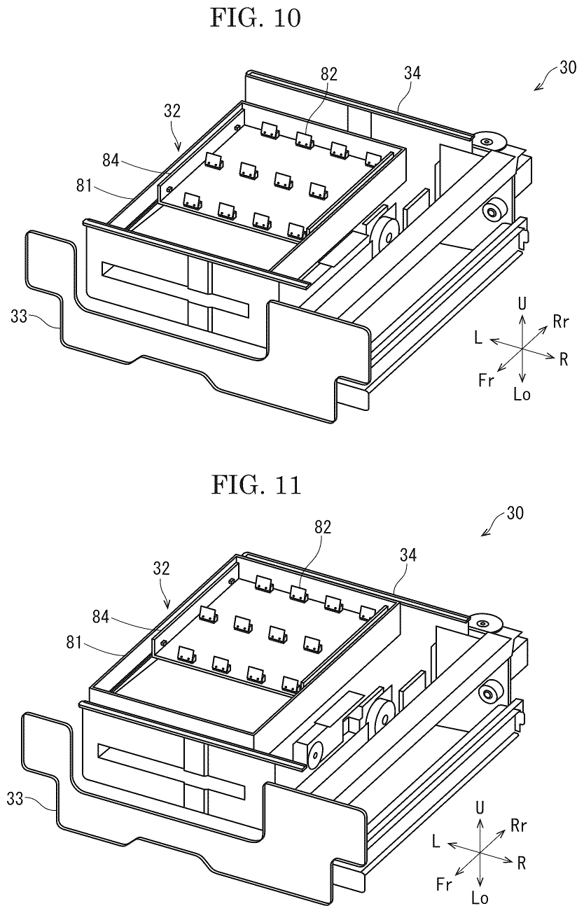

The head base 15 has a plurality (in this embodiment, twenty) of through-holes 15H. The through-hole 15H is formed in a rectangular shape elongated in the front-and-rear direction. The nozzle plate 14 (see FIG. 3, FIG. 7 and FIG. 14) is formed in a rectangular parallelepiped shape elongated in the front-and-rear direction as a whole, and has protrusions 14P protruding forward and rearward from the front and rear ends of the nozzle plate 14, respectively. The lower surface of the protrusions 14P are positioned higher than the nozzle surface 14F. The lower portion of the nozzle plate 14 including the nozzle surface 14F is fitted to the through-hole 15H. The head base 15 closes the gap between the inkjet heads 12. The nozzle surface 14F of the inkjet head 12 fitted in the through-hole 15H is exposed. A connection member 13C is provided below the rear protrusion 14P across the head base 15 (see FIG. 4 and FIG. 14).

[Maintenance Device] FIG. 5 is a block diagram showing an electrical configuration of the maintenance device 30. FIG. 8 to FIG. 11 are perspective views showing the maintenance device 30. The maintenance device 30 includes a frame 33, a carriage 34, a removing device 32, a lifting device 35, and a sliding device 36.

[Frame, Carriage] The frame 33 (see FIG. 8) is fixed to the body housing 3, and supports the carriage 34 and the conveying unit 7. The carriage 34 supports the removing device 32. The removing device 32 includes a blade 82.

[Lifting Device] The conveying unit 7 is supported by the frame 33 via the lifting device 35 (see FIG. 5). The lifting device 35 includes, for example, a ball screw, a belt driving device, and the like. The lifting device 35 lifts and lowers the conveying unit 7 to an image forming position (see FIG. 8) when the image forming operation is performed and to a lower retracted position (see FIG. 9) below the image forming position. When the conveying unit 7 is moved to the image forming position, the conveying unit 7 is positioned so that a distance between the conveying belt 21 and the nozzle surface 14 F becomes a distance suitable for the image formation. When the conveying unit 7 is moved to the lower retracted position, a space in which the removing device 32 can be moved is formed between the upper surface of the conveying belt 21 and the nozzle surface 14F.

[Sliding Device] The carriage 34 is supported by the frame 33 via the sliding device 36 (see FIG. 5). The sliding device 36 includes, for example, a ball screw, a belt drive device, a rack and pinion, and the like. The removing device 32 is supported by the carriage 34, and slides in the left-and-right direction together with the carriage 34 by the sliding device 36. When the conveying unit 7 is positioned at the lower retracted position, the sliding device 36 slides the removing device 32 to a lateral retracted position (see FIG. 9) not facing the image forming unit 6 and a facing position (see FIG. 10) facing the image forming unit 6.

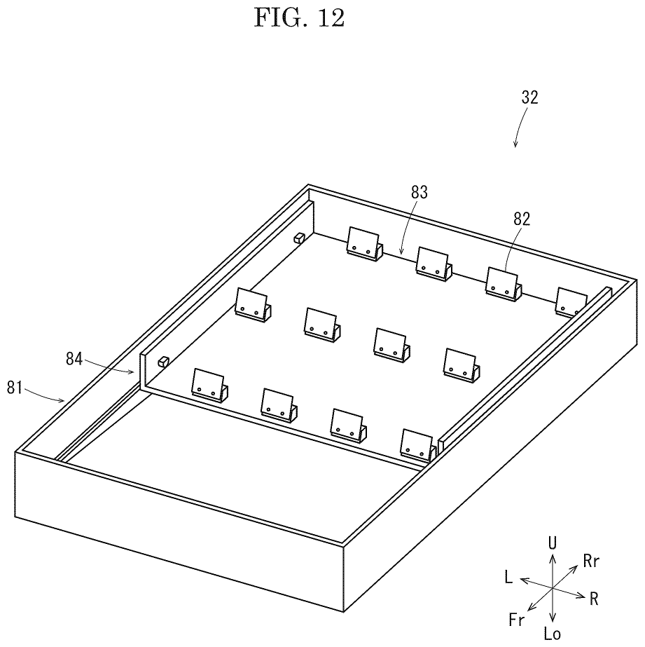

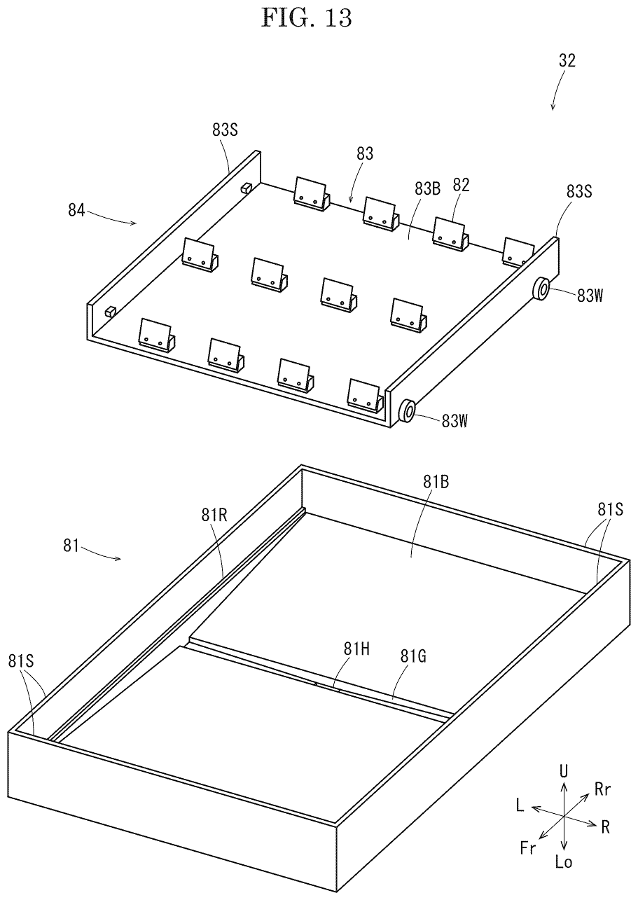

In the facing position, the removing device 32 can be moved upward and downward by using the conveying unit 7. Specifically, the conveying unit 7 can move upward and downward inside the carriage 34 with the removing device 32 placed on the upper portion of the conveying unit 7. The lifting device 35 lifts and lowers the removing device 32 to a separated position where the blade 82 is separated from the nozzle surface 14F (see FIG. 10) and a contact position where the blade 82 comes into contact with the nozzle surface 14F (see FIG. 11).

[Removing Device] FIG. 12 is a perspective view showing the removing device 32. FIG. 13 is a disassembled view showing the removing device 32. The removing device 32 includes a waste liquid tray 81 and a blade unit 84 sliding with respect to the waste liquid tray 81.

[Waste Liquid Tray] The waste liquid tray 81 is fixed to the carriage 34. The waste liquid tray 81 has a rectangular bottom portion 81B when viewed from the upper side, and an upright side wall portion 81S provided around the entire circumference of the front, rear, right and left edges of the bottom portion 81B. In other words, the waste liquid tray 81 is opened to the inkjet head 12. The upper edge portion of the side wall portion 81S is formed at an equal height over the entire circumference. A size of the waste liquid tray 81 in the front-and-rear direction and the left-and-right direction (see FIG. 13 to FIG. 15) is smaller than a size of the head base 15 in the front-and-rear direction and the left-and-right direction.

A size of the waste liquid tray 81 in the front-and-rear direction and left-and-right direction is larger than that of the circumscribed rectangle R (see FIG. 7) that includes all the nozzle surfaces 14F. In other words, a length of the waste liquid tray 81 in the front-and-rear direction (see FIG. 14) is longer than a length from the front end of the nozzle surface 14F of the frontmost inkjet head 12 to the rear end of the nozzle surface 14F of the rearmost inkjet head 12. A length of the waste liquid tray 81 in the left-and-right direction (see FIG. 16) is longer than a length from the left end of the nozzle surface 14F of the leftmost inkjet head 12 to the right end of the nozzle surface 14F of the rightmost inkjet head 12.

The upper surface of the bottom portion 81B (see FIG. 13) is inclined so as to be lower from both front and rear ends toward the center. A groove 81G along the left-and-right direction is provided at the center of the bottom portion 81B in the front-and-rear direction. The groove 81G is inclined so as to be lower from the left and right ends toward the center. A discharge port 81H penetrating in the upper-and-lower direction is provided at the center of the groove 81G in the left-and-right direction. A suction pump 68 and a waste liquid tank 69 are connected to the discharge port 81H (see FIG. 4). Rails 81R whose longitudinal direction along the front-and-rear direction are provided at both left and right end portions of the waste liquid tray 81.

[Blade Unit] The blade unit 84 (see FIG. 13) includes blades 82 and a support plate 83 for supporting the blades 82. The blade 82 is a flexible plate-like member made of rubber or the like. A plurality (in this embodiment, twenty) of the blades 82 are arranged in the same positional relation as the inkjet heads 12. The support plate 83 has a bottom portion 83B and upright side wall portions 83S provided at both right and left ends of the bottom portion 83B. Wheels 83 W supported by shafts whose axial directions are along the left-and-right direction are provided near both front and rear end portions of the right and left side wall portions 83S. The wheels 83 W are placed on the rails 81R and roll along the rails 81R. The removing device 32 is provided with a driving device 85 (see FIG. 5) for sliding the blade unit 84 in the front-and-rear direction. The driving device 85 includes, for example, a ball screw, a belt driving device, a rack and pinion, and the like.

[Cleaning Liquid Supply Device] The inkjet recording apparatus 1 includes a cleaning liquid supply device 13 for supplying a cleaning liquid (see FIG. 3 and FIG. 4). The cleaning liquid supply device 13 includes a cleaning liquid tank 13T for storing the cleaning liquid, a pump 13P for feeding the cleaning liquid from the cleaning liquid tank 13T, a sub-tank 13S for storing the cleaning liquid supplied from the cleaning liquid tank 13T, and the connection member 13C provided on the rear side of the nozzle plate 14. The connection member 13C has a supply port 13A penetrating in the upper-and-lower direction. The cleaning liquid swells from the supply port 13A by adjusting a liquid level in the sub-tank 13S. The cleaning liquid is supplied to the nozzle surface 14F by scraping the cleaning liquid from the supply port 13A by the blade 82.

Next, an operation of the maintenance device 30 will be described. The following operations are executed by the control part 2 controlling the respective parts of the maintenance device 30.

When the image forming job is executed (see FIG. 8), the removing device 32 is arranged at the lateral retracted position, and the conveying unit 7 is arranged at the image forming position.

A purge processing and a wiping processing are executed at predetermined timing. The predetermined timing is, for example, when a predetermined time has elapsed since the image forming job is completed. In the case of performing the purge processing and the wiping processing, the control part 2 moves the conveying unit 7 to the lower retracted position by the lifting device 35 (see FIG. 9), and moves the carriage 34 to the facing position by the sliding device 36 (see FIG. 10). At this time, the removing device 32 is positioned at the separated position. Next, the control part 2 lifts the conveying unit 7 by the lifting device 35 to lift the removing device 32 to the contact position (see FIG. 11).

In the contact position, the upper edge of the side wall portion 81S of the waste liquid tray 81 is pressed against the head base 15 over the entire circumference (see FIG. 14 and FIG. 16). The lower portion of the nozzle plate 14 of each inkjet head 12 is fitted into the through-hole 15H of the head base 15. That is, the waste liquid tray 81, the head base 15, and the nozzle plate 14 form a space A. The blade unit 84 is arranged inside the space A.

The blade unit 84 is positioned at a wiping start position (see FIG. 14). The wiping start position is the rear end of the slidable range of the blade unit 84. At the wiping start position, the blade 82 is positioned on the rear side of the connection member 13C provided on the rear side of the nozzle surface 14F.

Subsequently, the control part 2 increases a pressure in the nozzle 14N of the inkjet head 12 to eject the ink (the purge processing). Next, the control part 2 swells the cleaning liquid from the supply port 13A of the connection member 13C, and then slides the blade unit 84 forward by the driving device 85 (the wiping processing). Then, the blade 82 scrapes the cleaning liquid from the supply port 13A and slides forward along the nozzle surface 14F. The blade 82 moves forward while being pressed against the nozzle surface 14F and bent, and scrapes the ink adhering to the nozzle surface 14F. The ink is diluted by the cleaning liquid, falls onto the waste liquid tray 81, and discharged from the discharge port 81H to the waste liquid tank 69.

The blade unit 84 stops at a wiping end position (see FIG. 15). The wiping end position is the front end of the slidable range of the blade unit 84. At the wiping end position, the blade 82 is positioned on the front side of the nozzle surface 14F.

In the present embodiment, since the gap between the plurality of the inkjet heads 12 is closes by the head base 15, leakage of the cleaning liquid upward from the gap between the plurality of inkjet heads 12 is suppressed. Since the waste liquid tray 81 is closed by the head base 15, leakage of the cleaning liquid to the outside of the waste liquid tray 81 is suppressed.

In the present embodiment, the effect of suppressing the leakage of the cleaning liquid can be obtained even if the space A is not closed, but since the effect of suppressing the leakage of the cleaning liquid increases as the closing performance of the space A is higher, a configuration for enhancing the closing performance of the space A may be added. For example, by providing a sealing material (not shown) at the upper edge of the side wall portion 81S of the waste liquid tray 81, the leakage of the cleaning liquid from between the waste liquid tray 81 and the head base 15 is suppressed. The sealing material may be provided on the lower surface of the head base 15.

After the wiping processing is completed, the control part 2 waits until the image forming job is input while the removing device 32 is disposed at the contact position. Since the nozzle surface 14F is housed in the space A during this time, an increase in viscosity of the ink in the nozzle 14N is suppressed. In addition, adhesion of the ink to the waste liquid tray 81 and the head base 15 is suppressed.

When the image forming job is inputted, the control part 2 lowers the removing device 32 to the separated position by the lifting device 35 (see FIG. 10), then slides the removing device 32 to the lateral retracted position by the sliding device 36 (see FIG. 9), lifts the conveying unit 7 to the image forming position by the lifting device 35 (see FIG. 8), and then executes the image forming job.

The inkjet recording apparatus 1 according to the present embodiment described above is provided with a plurality of the inkjet heads 12, the cleaning liquid supply device 13 for supplying the cleaning liquid to the inkjet heads 12, the removing device 32 for removing adhered material from the nozzle surfaces 14F of the inkjet heads 12, the closing member (the head base 15) for closing the gap between the inkjet heads 12, the surrounding member (the waste liquid tray 81) for surrounding the removing device 32 and having the opening on a side of the inkjet head 12, and the housing device (the lifting device 35) for housing the nozzle surfaces 14F in the space A formed by using the closing member (the head base 15) and the surrounding member (the waste liquid tray 81) when removing the adhered material by using the removing device 32. According to this configuration, the leakage of the cleaning liquid for cleaning the nozzle surface 14F can be suppressed.

Further, according to the inkjet recording apparatus 1 according to the present embodiment, the closing member (the head base 15) is integrated with the inkjet heads 12, and the housing device (the lifting device 35) forms the space A by bringing the closing member into contact with the surrounding member by moving the surrounding member (the waste liquid tray 81) According to this configuration, the fitting of the inkjet heads 12 to the head base 15 can be stabilized. Instead of the moving of the surrounding member (the waste liquid tray 81), the surrounding member and the closing member may be brought into contact with each other by moving of the closing member (the head base 15).

In the inkjet recording apparatus 1 according to the present embodiment, the closing member (the head base 15) has the through-holes 15H into which the inkjet heads 12 are fitted, and the nozzle surface 14F of the inkjet head 12 fitted in the through-hole 15H is exposed to the surrounding member (the waste liquid tray 81). According to this configuration, the infiltration of the cleaning liquid into the electric circuit provided in the inkjet head 12 can be prevented.

Further, according to the inkjet recording apparatus 1 according to the present embodiment, the housing device (the lifting device 35) houses the nozzle surface 14F in the space A during a period when the image formation by the inkjet heads 12 is not performed. According to this configuration, an increase in viscosity of the ink in the nozzle is suppressed. In addition, the adhesion of the ink to the waste liquid tray 81 and the head base 15 is suppressed.

The above embodiment may be modified as follows.

In the above embodiment, as the cleaning liquid supply device 13, an example is shown in which the blade 82 scrapes the cleaning liquid swollen from the supply port 13A of the connection member 13C, but the cleaning liquid supply device 13 may be configured to jet or spray the cleaning liquid toward the nozzle surface 14F. Specifically, a nozzle (not shown) for jetting or spraying the cleaning liquid is provided on the front side of each blade 82 of the blade unit 84. The nozzle slides in the front-and-rear direction with the blade 82. With this configuration, since a larger amount of the cleaning liquid is supplied to the nozzle surface 14F, the ink removing ability can be enhanced.

The above embodiment shows an example in which the housing device houses the nozzle surface 14F in the space A during a period in which the image formation by the inkjet heads 12 is not performed, but in addition, the cleaning liquid supply device 13 may supply the cleaning liquid to the nozzle surface 14F during a period in which the image formation by the inkjet heads 12 is not performed. For example, the cleaning liquid may be supplied to the nozzle surface 14F by periodically performing the wiping processing. According to this configuration, an increase in viscosity of the ink in the nozzle 14N can be suppressed.

In addition to the configuration of the above embodiment, the cleaning liquid supply device 13 may include a heater 13H (see FIG. 4) for heating the cleaning liquid. In the example shown in FIG. 4, the heater 13H is provided in the cleaning liquid tank 13T, but the heater 13H may be provided in the cleaning liquid tank 13T, the sub-tank 13S, or the passage through which the cleaning liquid flows. According to this configuration, the ink removing ability can be enhanced by softening the stuck ink and lowering a viscosity of the cleaning liquid.

In the above embodiment, the removing device 32 is slid into the space formed by lowering the conveying unit 7, but the removing device 32 may be slid into the space formed by lifting the image forming unit 6.

In the above embodiment, the head base 15 is integrated with the inkjet head 12, but the head base 15 may be provided in the waste liquid tray 81. In this case, the waste liquid tray 81 is always closed by the head base 15. When the removing device 32 is lifted from the separated position to the contact position at the facing position, the lower portion of the nozzle plate 14 is fitted to the through-hole 15H of the head base 15, and the gap between the inkjet heads 12 is closed.

In the above embodiment, the blade unit 84 slides in the front-and-rear direction with respect to the waste liquid tray 81, but the blade unit 84 may be fixed to the waste liquid tray 81 and may be configured to slide in the front-and-rear direction together with the waste liquid tray 81.

1. An inkjet recording apparatus comprising:
a plurality of inkjet heads;
a cleaning liquid supply device which supplies a cleaning liquid to the inkjet heads;
a removing device which removes adhered material from nozzle surfaces of the inkjet heads;
a closing member which closes a gap between the inkjet heads;
a surrounding member which surrounds the removing device and is opened toward the inkjet heads; and
a housing device which houses the nozzle surfaces in a space formed by the closing member and the surrounding member when the adhered material is removed by the removing device.

2. The inkjet recording apparatus according to claim 1, wherein
the closing member is formed integrally with the inkjet heads, and
the housing device brings the surrounding member into contact with the closing member by moving the surrounding member or the closing member to form the space.

3. The inkjet recording apparatus according to claim 2, wherein
the closing member has through-holes into which the inkjet heads are fitted, and
the nozzle surfaces of the inkjet heads fitted into the through-holes are exposed to the surrounding member.

4. The inkjet recording apparatus according to claim 1, wherein
the cleaning liquid supply device ejects or splays the cleaning liquid to the nozzle surfaces.

5. The inkjet recording apparatus according to claim 1, wherein
the housing device houses the nozzle surfaces in a period when an image forming operation by the inkjet heads is not performed.

6. The inkjet recording apparatus according to claim 5, wherein
the cleaning liquid supply device supplies the cleaning liquid in a period when an image forming operation by the inkjet heads is not performed.

7. The inkjet recording apparatus according to claim 1, wherein
the cleaning liquid supply device includes a heater which heats the cleaning liquid.
